(19) United States
(12) Patent Application Publication
(10) Pub. No.: US 2008/0061194 A1
(43) Pub. Date: Mar. 13, 2008

(54) Remote control unit stand

(76) Inventor: William T. Edwards, Philadelphia, PA (US)

Correspondence Address: William T. Edwards, P O Box 5140, Philadelphia, PA, 19141, US

(21) Appl. No.: 11/256,006

(22) Filed: Sep. 9, 2006

(51) Int. Cl. F16L 3/00

(52) U.S. Cl. 248/121; 248/222.41

(57) ABSTRACT

The remote control stand is designed to stand at 38 inches high. A circular base of 8-inches diameter and 1 (one) inch thick, weighing five pounds, sits flat on the ground. A stem of 38-inches rises from the center of the base and projects perpendicular to the base plane. (Thirty two) 32 inches above the base are two tubular pieces which project 4 inches on either side of the stem. These branches each hold an oval plate of about 6 inches long. The tips of these ovals point upwards and are recessed in the middle with a telephone-jack-type housing. Two elastic telephone-type cords of about 10-feet long anchor from the oval plate to the remote controls being secured. The remote controls rest on the ovals when they are not in use. This device as described in this abstract, the concert of elements to function in like manner, is the invention of William T. Edwards.

### BACKGROUND/PROBLEM

Manufacturers of television sets, stereo receivers, VCR's, CD and DVD players, tape decks and other electronic entertainment equipment generally provide remote control units designed to operate the specific product the consumer purchased. A problem many consumers encounter with having several remote control units is the inability to organize them and thus they become easily misplaced.

### SOLUTION

Referring to FIGS. 1-5 of the attached drawings, there is illustrated a remote control unit stand, generally designated 10, of the present invention which provides an effective solution to the aforementioned problem by providing means for organizing and holding one or more remote control units U at a known location.

The remote control unit stand 10 includes a base 12, at least one and preferably a plurality of receptacles or holders 14, and an elongated stem 16 having a lower end 16A rigidly attached on the base 12 and extending upright to an upper end 16B. The stand 10 has a cross tube 18 attached to the upright stem 16 at a location spaced a short distance below the upper end 16B of the stem 16 and substantially closer to the upper end 16B than to the lower end 16A thereof. The cross tube 18 has opposite sections 18A extending in opposite directions from the opposite sides of the upright stem 16. The holders 14 are rigidly attached to the outer ends 18B of the opposite sections 18A of the cross tube 18. The base 12, stem 16 and cross tube 18 can be fabricated from any suitable material, for example a plastic such as PVC or other material.

Each holder 14 includes a generally flat inner support plate 20 rigidly attached on an inner surface 22 thereof to the outer end 18B of one of the opposite sections 18A of the cross tube 18 such that the support plate 20 is disposed in a vertical orientation, an outer latch plate 24 having a keyhole 26 formed therethrough, and means in the form of a pair of spacer blocks 28 disposed between and attached to lateral edge portions 20A, 24A of the inner support plate 20 and outer latch plate 24 so as to position the outer latch plate 24 at a location spaced outwardly from the inner support plate 20 and define a channel 30 therebetween. The keyhole 26 of the outer latch plate 24 has an upper portion 26A larger in size than a lower portion 26B thereof. For each remote control unit U is provided with a button-type hook 32 which attaches to a rear side thereof by any suitable means such as a layer of adhesive 33 on an end of an inner portion 34 of the hook 32 which is smaller in diameter than an outer portion 36 of the hook 32. The inner portion 34 of the hook 32 has a diameter small than the widths of both the upper and lower portions 26A, 26B of the keyhole 26 in the outer latch plate 24 whereas the outer portion 36 has a diameter larger than that of the inner portion 34 and greater than the width of the lower portion 26B but less than the width of the upper portion 26A of the keyhole 26.

Once the hook 32 is attached to the remote control unit U, the remote control unit U is then moved so as to pass the outer portion 36 of the hook 32 through the upper portion 26A of the keyhole 26 which leaves the inner portion 34 of the hook 32 extending through the keyhole 26 and aligned above the lower portion 26B of the keyhole 26. The remote control unit U is then moved downward so as to pass the inner portion 34 of the hook 32 downward along the lower portion 26B of the keyhole 26 and lodge the outer portion 36 in the channel 30 behind the lower portion 26B of the keyhole 26 between the inner support plate 20 and outer latch plate 24. In such position of the hook 32, the remote control unit U is “latched” on the holder 14 at a position in front of the holer 14. By reversing the above-described movements of the remote control unit U, it can be “unlatched” and removed from the holder 14.

Also, each remote control unit U can be tethered to one of the holders 14 by an elongated flexible retaining cord 38 to prevent the remote control unit U from being carried away from the stand 10. While only one cross tube 18 and two holders 14 are shown in the drawings, it should be understood that more cross tubes 18 and holders 14 can be provided on the stand 10. The base 12 is preferably circular in shape, but is not so limited, and has sufficient weight to give the stand 10 a low center of gravity and to resist tipping over as a result of normal unlatching and relatching of the remote control units U from and to the holders 14. The stand 10 can be of any suitable size and weight. One suitable weight is within the range of 5 to 10 pounds and one suitable size is about three feet in height on a plastic base of about twelve inches in diameter.

Two drawing sheets containing FIGS. 1-5 are attached.

The above-named inventor claims all inventions herein disclosed.

### DESCRIPTION OF DRAWINGS

FIG. 1 is the front elevation of the invention. Part 16 is the stem. A wider stem-12 sit a top the base to provide firmness. 26 shows the two ovals which attach themselves to stem 18 on either side of 16.

FIG. 2 shows a remote control as it is linked by a retaining cord to piece 26, the oval.

FIG. 3 is the oval and the recess within it to retain a remote control when it rests on the stand. Numbers 32, 28 show the form of anchoring of the oval and the stem 18a and 18b.

FIG. 4 is the side view of the oval where the remote controls rest. It reveals the grooving of the ovals to allow for the remote controls to rest.

FIG. 5 is the top view of the oval plate and the way the remote control sits on the oval.

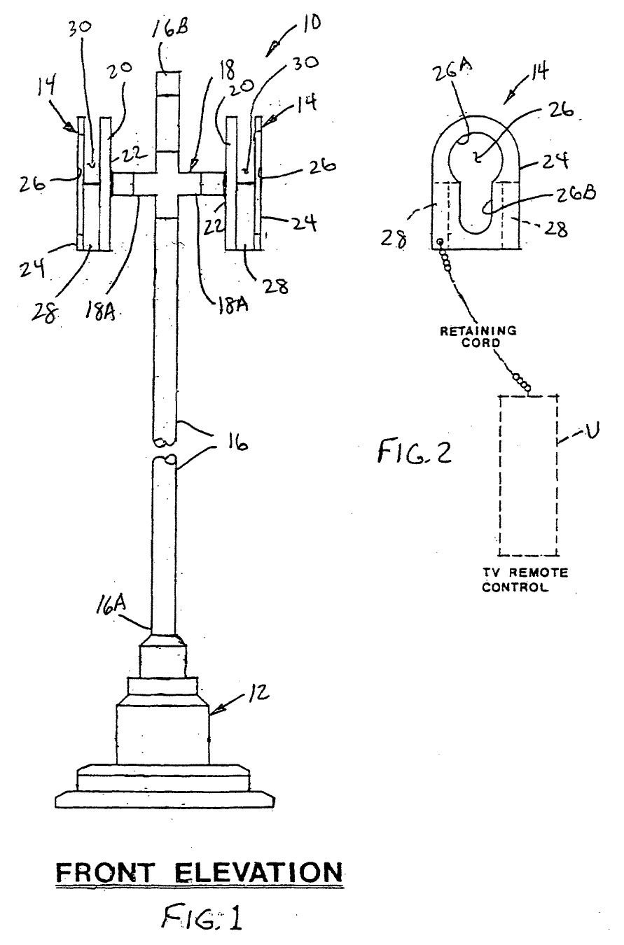

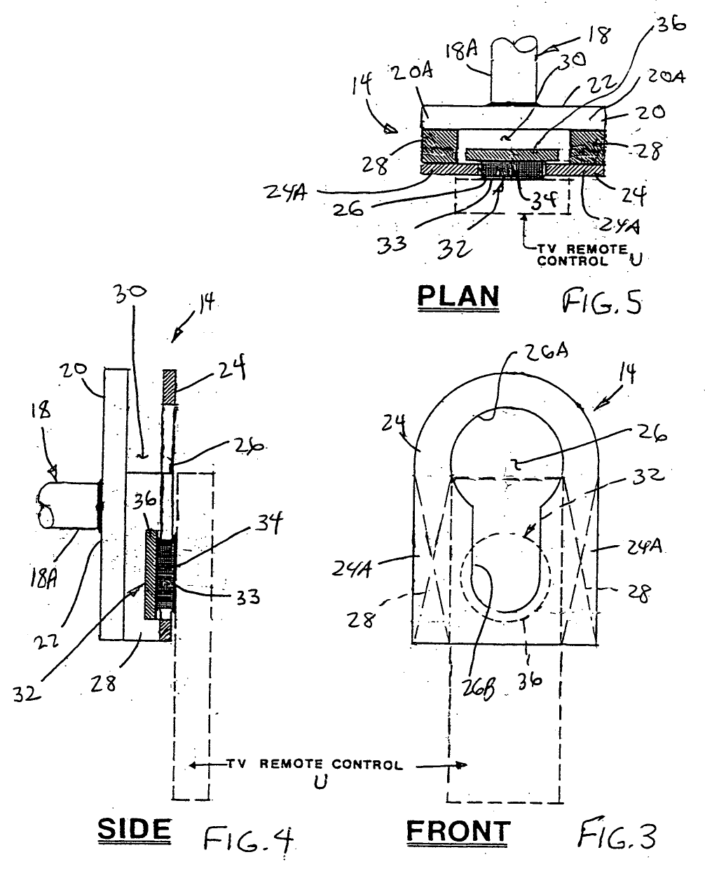

1. What I claim as my invention is the design of a Remote Control Stand which has a flat base, a vertical stem, an arm across the top, two ovals on either side functioning as anchor to some two cords, and also functioning as resting platforms for a remote control device as shown and described. The functioning of parts assembled in a similar manner and similar proportion is the subject of my claim.
